(19) United States
(12) Patent Application Publication
(10) Pub. No.: US 2015/0181204 A1
(43) Pub. Date: Jun. 25, 2015

(54) IMAGE PROCESSING APPARATUS, IMAGE PROCESSING METHOD, AND IMAGE DISPLAY DEVICE

(71) Applicant: Sony Corporation, Tokyo (JP)

(72) Inventors: Toru Nishi, Kanagawa (JP); Oliver Erdler, Stuttgart (DE); Thimo Emmerrich, Stuttgart (DE)

(21) Appl. No.: 14/413,941

(22) PCT Filed: Jun. 3, 2013
(86) PCT No.: PCT/JP2013/065334

§ 371 Date: Jan. 9, 2015

(30) Foreign Application Priority Data
Jul. 18, 2012 (JP) 2012-159764

(51) Int. Cl. H04N 13/04

(52) U.S. Cl. CPC H04N 13/0409

(57) ABSTRACT

A stereoscopic effect of an interpolation image is stabilized by properly performing, on a parallax image, processing of expanding a parallax of an object in a foreground toward a background at a boundary of the object.

A flat portion detection unit 701 detects a flat portion within an original image frame on the basis of a luminance signal or the like. A MIN filter 702 performs the processing of expanding the parallax in the foreground toward the background with respect to only the flat portion on the basis of the detected signal from the flat portion detection unit 701, whereby the application of the MIN filter 702 to a non-flat portion is inhibited. A MAX filter 703 then performs processing of expanding the parallax in the foreground toward the background on the parallax image processed by the MIN filter 702.

### TECHNICAL FIELD

A technology disclosed in the present description relates to an image processing apparatus and an image processing method, which are adapted to process a three-dimensional image, as well as an image display device and particularly relates to an image processing apparatus and an image processing method, which are adapted to provide a high-quality three-dimensional image by stabilizing a stereoscopic effect, as well as the image display device.

### BACKGROUND ART

Recently, a three-dimensional display system which displays a left image and a right image in a multiplexed fashion to allow a viewer to have a stereoscopic vision of the image is becoming widespread. Here, a parallax image between the left image and the right image corresponds to a coordinate value in three-dimensional space. The parallax image is required to generate a multi-view interpolation image at the time of performing naked eye three-dimensional display, for example. It is typical to employ a block matching method to calculate a parallax by searching a corresponding pixel between the left image and the right image.

It is typical to then adjust the parallax in the parallax image to control the stereoscopic effect of the three-dimensional image. There has been proposed an image processing apparatus, for example, which generates a stereoscopic image by converting a parallax in a parallax image such that the parallax corresponding to an image of a subject in a picked up image equals a predetermined value, the stereoscopic image being stereoscopically viewed by the viewer more easily without getting tired easily (refer to Patent Document 1, for example). Moreover, in order to obtain a desired stereoscopic effect, there has been proposed an image generation device which changes a parallax value of a region to be processed corresponding to the subject within the parallax image as well as adjusts the size of the subject corresponding to the region to be processed within the picked up image (refer to Patent Document 2, for example).

In general, one tends to feel that the stereoscopic effect is not stable at a boundary between an object in the foreground and the background. In order to solve this problem, there is known a method in which the parallax of the object within the parallax image is expanded toward the background at the boundary of the object. There has been proposed a three-dimensional image generation device, for example, which expands the parallax of the object within the parallax image at the boundary of the object by incrementing the value of the parallax of a part corresponding to the object while applying a MAX filter to the parallax image (refer to Patent Document 3, for example).

The object is normally placed toward the foreground with respect to the background. When the MAX filter is applied to the parallax image having the distribution of the parallax value as indicated by a bold line in FIG. 10(A), for example, the distribution changes to what is indicated by a bold dotted line in FIG. 10(B) (where, in the figure, a horizontal axis represents a horizontal pixel position, and a vertical axis represents the parallax value at a corresponding pixel position). When the MAX filter is applied to the parallax image, the parallax value of the object is incremented and, as a result, the parallax value of the background region is replaced by the parallax value of the object (that is, the boundary of the foreground corresponding to the object is expanded to the background), whereby the boundary of the object is expanded as one can see from FIG. 10(B).

Where a simple method of applying the MAX filter to the parallax image is employed, however, there is a problem that incorrect information is spread by the application of the MAX filter when the incorrect information is included in parallax information, rather causing the stereoscopic effect to be unstable.

It is assumed in the example illustrated in FIG. 10(A) that the object is placed toward the foreground with respect to the background. In contrast, there is a case where a relationship of the parallax between the foreground and the background is reversed in the process of calculating the parallax. Where the object in the foreground is placed toward the background as indicated by a bold line illustrated in FIG. 11(A), for example, the parallax cannot be calculated correctly due to the background being flat, in which case the parallax of the object equals zero. When the MAX filter is applied to a parallax image having the distribution of the parallax value as illustrated in FIG. 11(A), the boundary of the object recedes as indicated by a bold dotted line in FIG. 11(B). That is, the area of the object is reduced by the MAX filter processing, rather causing the stereoscopic effect to be unstable.

### CITATION LIST

### Patent Document

Patent Document 1: JP 2011-250059 A

Patent Document 2: JP 2012-105172 A

Patent Document 3: US 2010/0316284 A

### SUMMARY OF THE INVENTION

### Problems to be Solved by the Invention

An object of the technology disclosed in the present description is to provide superior image processing apparatus and image processing method which can provide a high-quality three-dimensional image by stabilizing the stereoscopic effect, as well as to provide an image display device.

Another object of the technology disclosed in the present description is to provide superior image processing apparatus and image processing method which properly performs, on a parallax image, processing of expanding a parallax of an object in the foreground toward the background at the boundary of the object to be able to stabilize the stereoscopic effect of an interpolation image that is generated on the basis of the parallax image, as well as to provide the image display device.

### Solutions to Problems

The present application has been made in consideration of the aforementioned problems where a technology described in claim 1 is an image processing apparatus including:

a flat portion detection unit which detects a flat portion of an original image;

a MIN filter which inputs a parallax image of the original image and performs processing on the flat portion detected by the flat portion detection unit to expand a parallax in a background toward a direction of a foreground; and

a MAX filter which inputs the parallax image processed by the MIN filter and performs processing of expanding a parallax in the foreground toward a direction of the background.

According to a technology described in claim 2 of the present application, the number of taps of the MIN filter included in the image processing apparatus of claim 1 equals no less than one time and no more than two times as many as the number of taps of the MAX filter.

A technology described in claim 3 of the present application is an image processing method including:

a flat portion detection step of detecting a flat portion of an original image;

a MIN filtering step of inputting a parallax image of the original image and performing processing on the flat portion detected in the flat portion detection step to expand a parallax in a background toward a direction of a foreground; and

a MAX filtering step of inputting the parallax image processed in the MIN filtering step and performing processing of expanding a parallax in the foreground toward a direction of the background.

A technology described in claim 4 of the present application is an image processing apparatus including:

a flat portion detection unit which detects a flat portion of an original image; and

a MAX filter which inputs a parallax image of the original image and performs processing on the flat portion detected by the flat portion detection unit to expand a parallax in a foreground toward a direction of a background.

A technology described in claim 5 of the present application is an image display device including:

an initial parallax generation unit which generates an initial parallax from an original image;

a parallax correction unit which performs MIN filter processing of expanding a parallax in a background toward a direction of a foreground with respect to a flat portion of the original image and then performs MAX filter processing of expanding a parallax in the foreground toward a direction of the background;

an interpolation image generation unit which generates an interpolation image interpolating the original image on the basis of the corrected parallax;

an image integration unit which integrates the original image and the interpolation image; and

a display unit which displays the original image or the image integrated by the image integration unit.

### Effects of the Invention

According to the technology disclosed in the present description, there can be provided the superior image processing apparatus and image processing method as well as the image display device, the image processing apparatus and the image processing method being capable of efficiently stabilizing the stereoscopic effect in a naked eye three-dimensional image or the like by focusing on the characteristic that the stereoscopic effect is more unstable at the boundary between the object in the foreground and the flat background to use information on the flat portion of the original image and perform the processing of expanding the boundary of the object toward the background with use of the MAX filter.

Moreover, according to the technology disclosed in the present description, there can be provided the superior image processing apparatus and image processing method as well as the image display device, the image processing apparatus and the image processing method being capable of efficiently stabilizing the stereoscopic effect while using the MIN filter and the MAX filter together to stably perform the processing of expanding the boundary of the object toward the background by temporarily processing the parallax image with the MIN filter with use of flat information of the image and then applying the MAX filter.

Other objects, features and advantages pertaining to the technology disclosed in the present description will become apparent by the more detailed description provided hereinafter in the embodiments and the accompanying drawings.

### BRIEF DESCRIPTION OF DRAWINGS

FIG. 1 is a diagram schematically illustrating a functional configuration of an image display device 100 to which a technology disclosed in the present description can be applied.

FIG. 2 is a block diagram illustrating a functional configuration which performs processing to realize multi-view within a video signal processing unit 120.

FIG. 3 is a diagram illustrating an internal configuration of an interpolation frame generation unit 202.

FIG. 4 is a diagram illustrating an example of an internal configuration of a parallax correction unit 304.

FIGS. 5(A) and 5(B) are diagrams illustrating a corrected result of a parallax image corrected by the parallax correction unit 304 illustrated in FIG. 4.

FIGS. 6(A) and 6(B) are diagrams illustrating a corrected result of the parallax image corrected by the parallax correction unit 304 illustrated in FIG. 4.

FIG. 7 is a diagram illustrating an example of an internal configuration of the parallax correction unit 304 which uses a MIN filter and a MAX filter together.

FIGS. 8(A) to 8(C) are diagrams illustrating a corrected result of the parallax image corrected by the parallax correction unit 304 illustrated in FIG. 7.

FIGS. 9(A) to 9(C) are diagrams illustrating a corrected result of the parallax image corrected by the parallax correction unit 304 illustrated in FIG. 7.

FIGS. 10(A) and 10(B) are diagrams illustrating an example in which the MAX filter is applied to the parallax image.

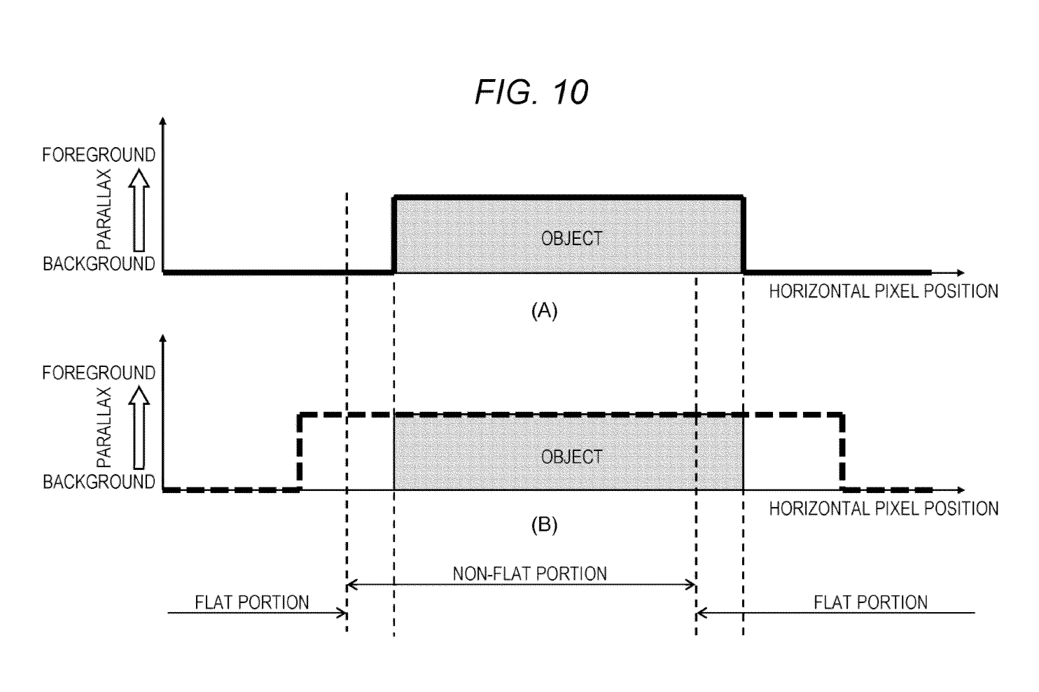

FIGS. 11(A) and 11(B) are diagrams illustrating an example in which the MAX filter is applied to a parallax image in which a parallax relationship between a foreground and a background is reversed.

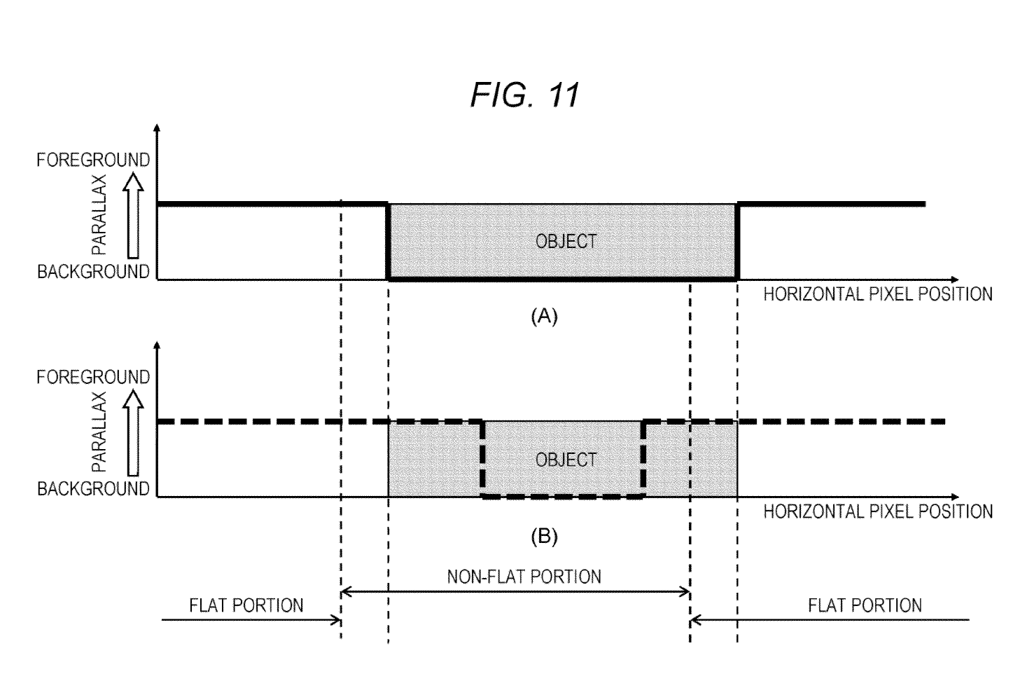

### MODES FOR CARRYING OUT THE INVENTION

Embodiments of a technology disclosed in the present description will be hereinafter described in detail with reference to the drawings.

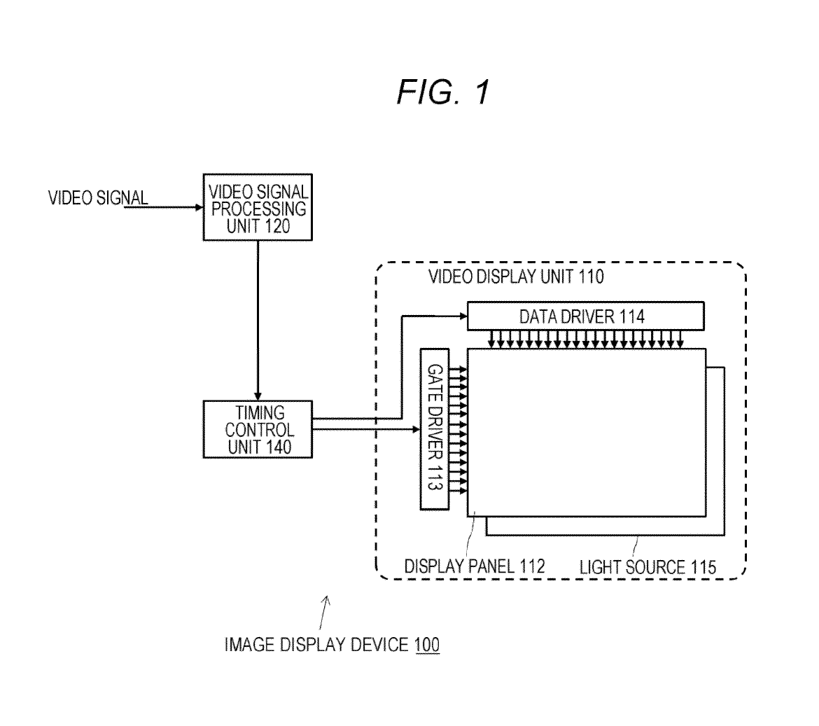

FIG. 1 schematically illustrates a functional configuration of an image display device 100 to which a technology disclosed in the present description can be applied. The image display device 100 illustrated in the figure inputs a three-dimensional video signal formed of a left image and a right image, for example, performs processing to realize a high frame rate or multi-view as needed, and spatially multiplexes images of a plurality of viewpoints to display the images on a screen, for example. A viewer can thus have a three-dimensional view of the image with a naked eye.

The image display device 100 includes a video display unit 110, a video signal processing unit 120, and a timing control unit 140.

Upon receiving a video signal from an external device of the video signal processing unit 120, the video signal processing unit 120 executes various signal processings to make the signal suitable for video display in the video display unit 110 and then outputs the signal. Note that the “external device” from which the video signal is transmitted can be a receiver used in a digital broadcast or a content reproduction device such as a Blu-ray disc player.

The video signal processing unit 120 performs image quality correction processing of enhancing the definition or improving a contrast of an image, for example. Moreover, in the present embodiment, the video signal processing unit 120 generates an interpolation frame which interpolates a viewpoint image used to realize multi-view. Processing related to the generation of the interpolation frame will be described later.

The video signal processed by the video signal processing unit 120 is input to the timing control unit 140. The timing control unit 140 converts each of a left-eye image signal D_{L} and a right-eye image signal D_{R} being input into a signal to be input to the video display unit 110 as well as generates a pulse signal used in the operation of a panel drive circuit formed of a gate driver 113 and a data driver 114.

The video display unit 110 displays a video according to a signal applied from the outside. The video display unit 110 includes a display panel 112, the gate driver 113, the data driver 114, and a light source 115.

The gate driver 113 is a drive circuit which generates a signal used to perform sequential drive, and outputs a drive voltage to a gate bus line connected to each pixel within the display panel 112 in accordance with the signal transmitted from the timing control unit 140. The data driver 114 is a drive circuit which outputs a drive voltage based on a video signal, and generates/outputs a signal to be applied to a data line on the basis of the signal transmitted from the timing control unit 140 and the video signal output from the video signal processing unit 120.

The display panel 112 includes a plurality of pixels arrayed in a grid form, for example. When a liquid crystal display panel is used as the display panel, a liquid crystal molecule oriented in a predetermined state is sealed between transparent plates such as glass so that an image is displayed in response to a signal applied from the outside. As described above, a signal is applied to the display panel 112 by the gate driver 113 and the data driver 114.

The light source 115 is a backlight provided in the farthest part of the video display unit 110 as seen from the viewer side. When displaying an image on the video display unit 110, the light source 115 emits unpolarized white light to the display panel 112 placed on the viewer side.

Note that while the embodiment using the liquid crystal display as the video display unit 110 is described in the present description, the gist of the technology disclosed in the present description is not limited to what is described herein. The present invention can be similarly applied to another display which is configured by forming a single pixel with a cell of a plurality of color components such as an OLED (Organic Light Emitting Diode) or an LED (Light Emitting Diode) and arranging a plurality of pixels in order in horizontal and vertical directions.

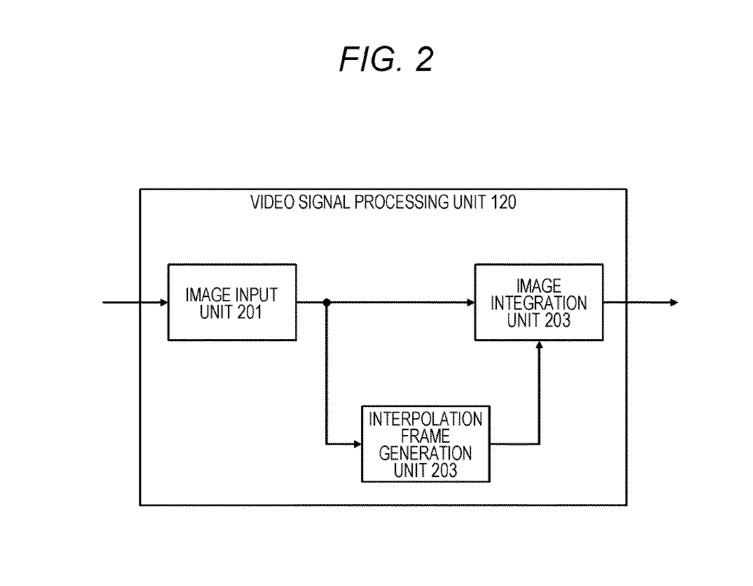

FIG. 2 illustrates a functional block diagram which performs processing to realize multi-view within the video signal processing unit 120.

An image input unit 201 inputs a video signal formed of a time sequence of an image frame. It is assumed in the present embodiment that a three-dimensional image signal formed of a left image and a right image is input.

An interpolation frame generation unit 202 generates an interpolation frame to realize multi-view from the image frame being input.

An image integration unit 203 generates a multi-view image signal by inserting the interpolation frame generated by the interpolation frame generation unit 202 into the original image frame.

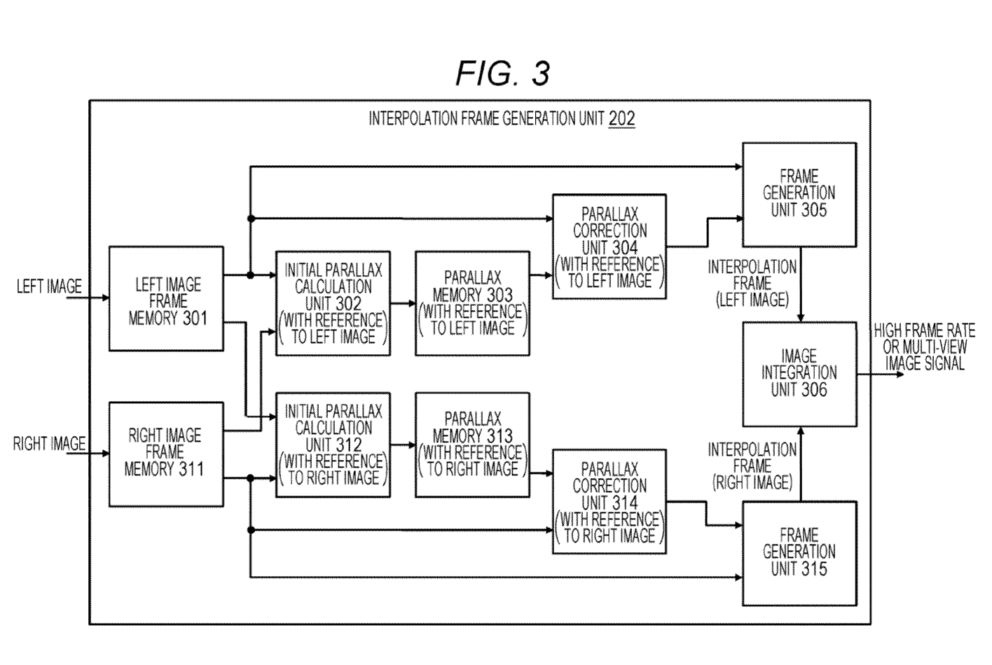

FIG. 3 illustrates an internal configuration of the interpolation frame generation unit 202.

A left image frame memory 301 and a right image frame memory 311 store the left image and the right image of the input three-dimensional image signal, respectively.

An initial parallax calculation unit 302 reads temporally corresponding left image and right image from the left image frame memory 301 and the right image frame memory 311, respectively, employs a block matching method to calculate an initial parallax image based on the left image, and writes the image into a parallax memory 303. Likewise, an initial parallax calculation unit 312 employs the block matching method to calculate an initial parallax image based on the right image and writes the image into a parallax memory 313.

Next, a parallax correction unit 304 performs correction processing on the initial parallax image calculated on the basis of the left image. Likewise, a parallax correction unit 314 performs correction processing on the initial parallax image calculated on the basis of the right image. The parallax correction units 304 and 314 in the present embodiment perform the correction processing to provide a stable stereoscopic effect in displaying a naked eye three-dimensional image.

Then, a frame generation unit 305 shifts for each pixel a left image frame, which is read from the left image frame memory 301, in the horizontal direction on the basis of the corrected parallax image based on the left image, and generates an interpolation frame for the left image. Likewise, a frame generation unit 315 shifts for each pixel a right image frame, which is read from the right image frame memory 311, in the horizontal direction on the basis of the corrected parallax image based on the right image, and generates an interpolation frame.

Subsequently, the interpolation frame of each of the left image and the right image is successively output from an image output unit 306 to the image integration unit 203.

There will now be described the correction processing performed by the parallax correction unit 304 on the initial parallax based on the left image. Description of the correction processing performed by the parallax correction unit 314 on the initial parallax based on the right image will be omitted as the processing is similar to that performed by the parallax correction unit 304.

While there is known a method of expanding the parallax of an object within a parallax image toward a background at the boundary of the object in order to provide the stable stereoscopic effect in displaying the naked eye three-dimensional image (refer to Patent Document 6, for example), there is a problem with a simple method of applying a MAX filter to the parallax image that incorrect information included in the parallax image is spread to rather make the stereoscopic effect unstable.

In general, one tends to feel that the stereoscopic effect is not stable at a boundary between the object in a foreground and the background. It is often the case that the object is non-flat while the background is flat in an original image. The sky is an example of such background. Accordingly, in the present embodiment, the parallax correction unit 304 is adapted to control the processing of expanding the boundary of the object within the parallax image toward the background in accordance with information on a flat portion of an input image.

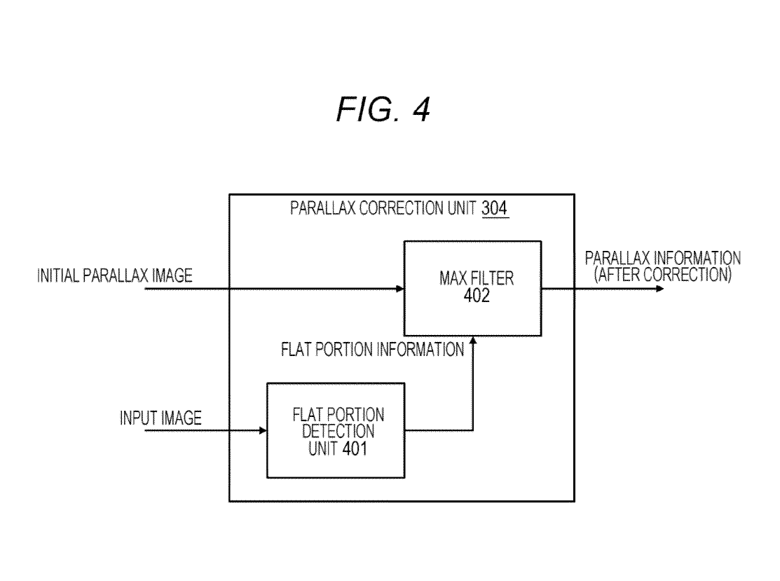

FIG. 4 illustrates an example of an internal configuration of the parallax correction unit 304. The parallax correction unit 304 illustrated in the figure includes a flat portion detection unit 401 and a MAX filter 402 and is configured to control the processing performed by the MAX filter 402 in accordance with the information on the flat portion obtained by the flat portion detection unit 401.

The flat portion detection unit 401 reads an input image from the left image frame memory 301, detects the flat portion within the original image frame on the basis of a luminance signal or the like, and outputs the detected signal to the MAX filter 402.

The MAX filter 402 reads the initial parallax image based on the left image from the parallax memory 303 and performs processing of expanding the parallax in the foreground toward the background with respect to only the flat portion on the basis of the detected signal from the flat portion detection unit 401, whereby the application of the MAX filter 402 to a non-flat portion is inhibited.

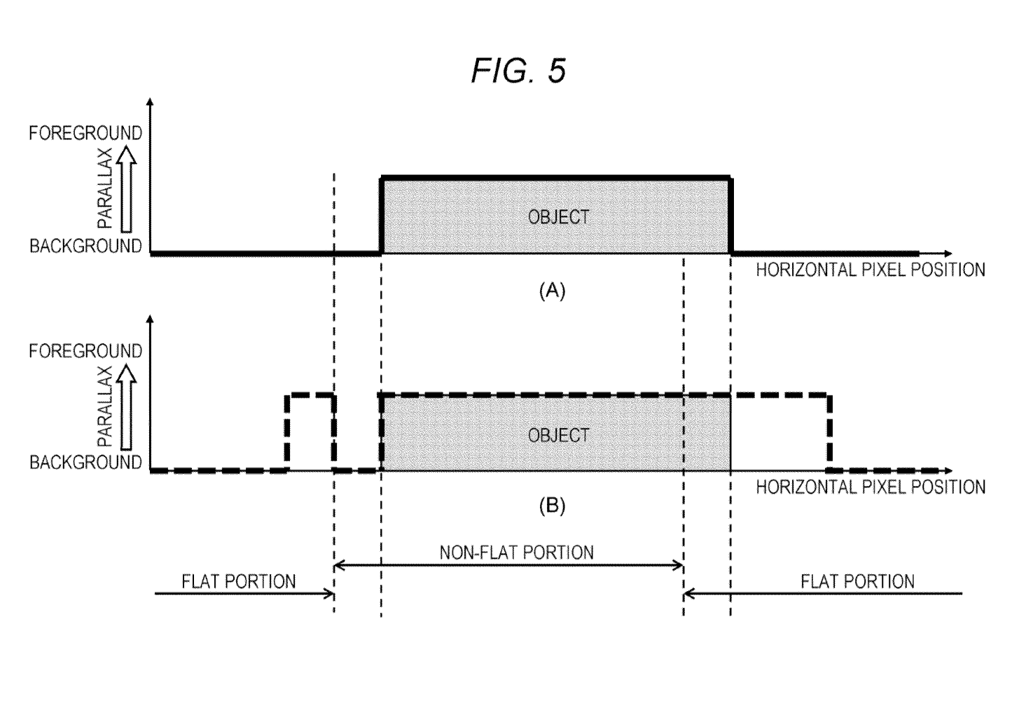

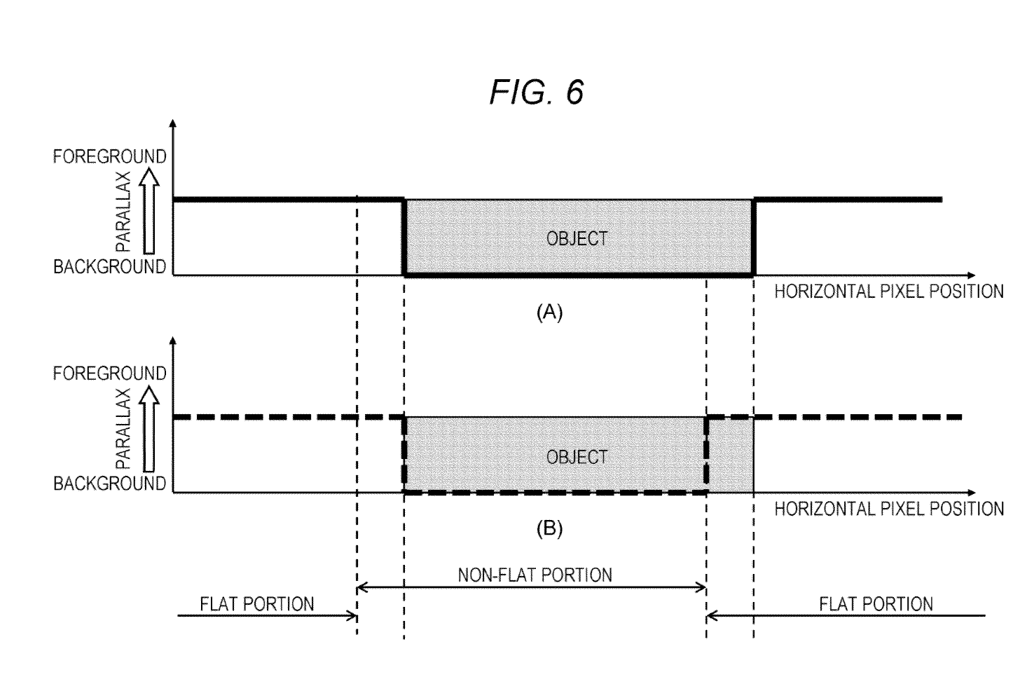

FIGS. 5(A) and 5(B) as well as 6(A) and 6(B) illustrate a corrected result of the parallax image corrected by the parallax correction unit 304 illustrated in FIG. 4. FIGS. 5(A) and 5(B) illustrate a correction example when the object is placed toward the foreground with respect to the background, while FIGS. 6(A) and 6(B) illustrate a correction example when the object in the foreground is placed toward the background. In both FIGS. 5(A) and 5(B) and FIGS. 6(A) and 6(B), the object is located roughly at the center of the parallax image along a horizontal line, and a left edge of the non-flat portion is expanded outside (to a background side) from the left boundary of the object while a right edge of the non-flat portion is shrunk from the right boundary of the object. The boundary of the flat portion and the non-flat portion does not correspond with the boundary of the object because there is assumed a case where the boundary of the flat portion calculated by the flat portion detection unit 401 does not always correspond accurately with the boundary of the object. It is generally difficult to match the boundary of the flat portion with the boundary of the object, where the aforementioned assumed case occurs frequently.

The processing performed by the MAX filter 402 to expand the parallax in the foreground toward the background is inhibited in the non-flat portion. As indicated by a bold line in the example illustrated in FIG. 5(A), the object is placed toward the foreground with respect to the background. Here, the right edge of the non-flat portion is shrunk from the right boundary of the object, so that processing by the MAX filter 402 can be performed on the right edge of the boundary of the object. As a result, the parallax of the object is expanded toward the background as indicated by a dotted line in FIG. 5(B), thereby allowing the intended effect to be exerted.

On the other hand, as indicated by the bold line in FIG. 5(A), the left edge of the non-flat portion is expanded from the left boundary of the object, so that the processing by the MAX filter 402 is not performed on the left side of the boundary of the object. On the contrary, the MAX filter 402 is applied to a portion where the non-flat portion is switched to the flat portion so that the parallax of the object is copied to cause an unnecessary isolated point in the foreground separated from the object (foreground), namely an error of the parallax information, on the left side of the boundary of the object as indicated by the dotted line in FIG. 5(B).

Moreover, as indicated by a bold line in the example illustrated in FIG. 6(A), the object is placed toward the background. In this case, the left edge of the non-flat portion is expanded outside (to the background side) from the left boundary of the object, so that the processing by the MAX filter 402 is not performed on the left edge of the boundary of the object and that no side effect occurs. On the other hand, the right edge of the non-flat portion is shrunk from the right boundary of the object, so that processing by the MAX filter 402 is performed on the right edge of the boundary of the object. As a result, the parallax of the background is expanded toward the object as indicated by a dotted line in FIG. 6(B), thereby causing the right edge of the object to shrink and the intended effect to not be exerted.

Now, the present applicant further proposes a method of using a MIN filter and the MAX filter together. That is, the stereoscopic effect is efficiently stabilized by temporarily processing the parallax image by the MIN filter with use of the flat information of the image and thereafter applying the MAX filter to stably perform the processing of expanding the parallax of the object in the foreground toward the background at the boundary of the object.

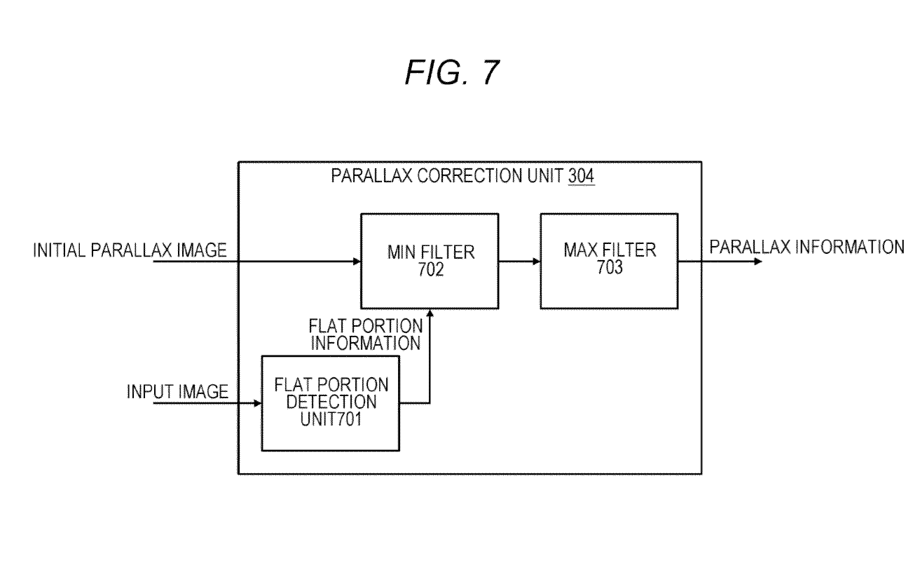

FIG. 7 illustrates an example of an internal configuration of a parallax correction unit 304 which uses the MIN filter and the MAX filter together. The parallax correction unit 304 illustrated in the figure includes a flat portion detection unit 701, a MIN filter 702, and a MAX filter 703.

The flat portion detection unit 701 reads an input image from the left image frame memory 301, detects a flat portion within the original image frame on the basis of a luminance signal or the like, and outputs the detected signal to the MIN filter 702.

The MIN filter 702 reads an initial parallax image based on a left image from the parallax memory 303 and performs processing of expanding the parallax in the foreground toward the background with respect to only the flat portion on the basis of the detected signal from the flat portion detection unit 701, whereby the application of the MIN filter 702 to a non-flat portion is inhibited.

The MAX filter 703 then performs processing of expanding the parallax in the foreground toward the background on the parallax image processed by the MIN filter 702. Unlike the example of the configuration illustrated in FIG. 4, the MAX filter 703 performs the processing on the parallax image regardless of the flat portion and the non-flat portion of the original image.

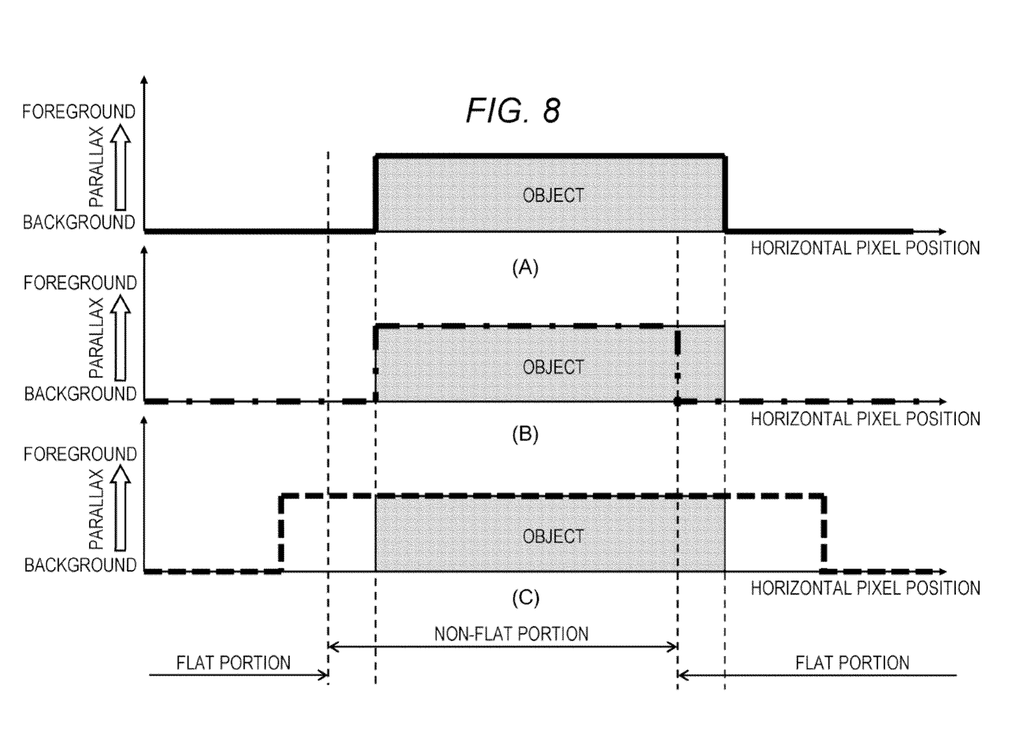

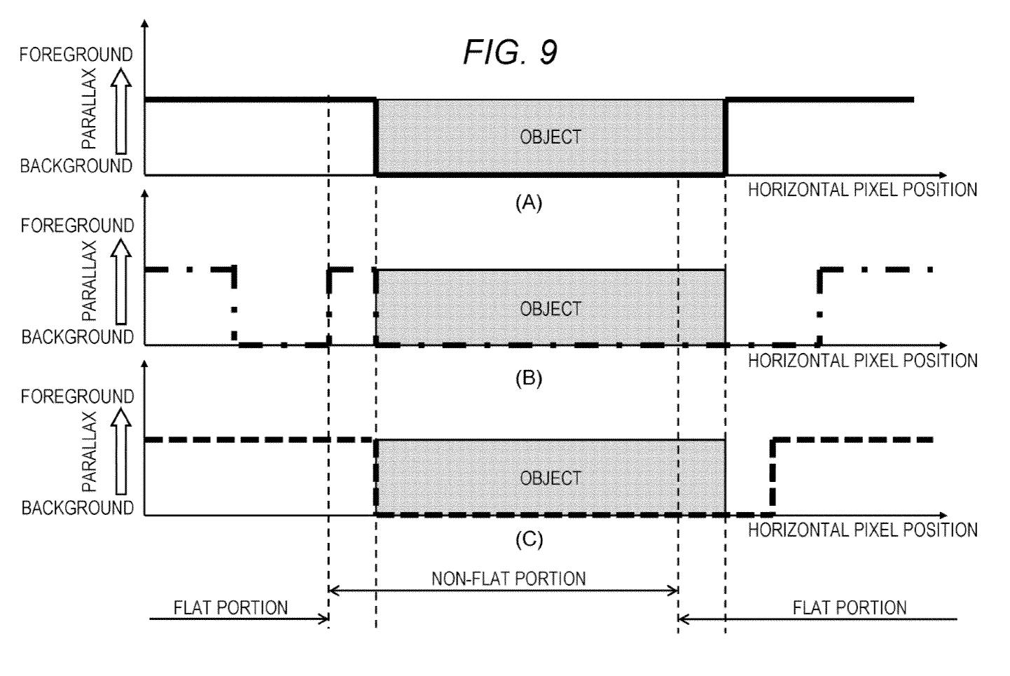

FIGS. 8(A) to 8(C) as well as 9(A) to 9(C) illustrate a corrected result of the parallax image corrected by the parallax correction unit 304 illustrated in FIG. 7. FIGS. 8(A) to 8(C) illustrate a correction example when the object is placed toward the foreground with respect to the background, while FIGS. 9(A) to 9(C) illustrate a correction example when the object in the foreground is placed toward the background. In both FIGS. 8(A) to 8(C) and FIGS. 9(A) to 9(C), as with the aforementioned case, the object is located roughly at the center of the parallax image along a horizontal line, and a left edge of the non-flat portion is expanded outside (to the background side) from the left boundary of the object while a right edge of the non-flat portion is shrunk from the right boundary of the object. The boundary of the flat portion and the non-flat portion does not correspond with the boundary of the object because there is assumed a case where the boundary of the flat portion calculated by the flat portion detection unit 701 does not always correspond accurately with the boundary of the object. It is generally difficult to match the boundary of the flat portion with the boundary of the object, where the aforementioned assumed case occurs frequently.

The processing performed by the MIN filter 702 to expand the parallax in the background toward the foreground is inhibited in the non-flat portion. As indicated by a bold line in the example illustrated in FIG. 8(A), the object is placed toward the foreground with respect to the background. Here, the right edge of the non-flat portion is shrunk from the right boundary of the object, so that the processing by the MIN filter 702 can be performed on the right edge of the boundary of the object. As a result, the parallax of the background is expanded toward the foreground as indicated by a chain line in FIG. 8(B), thereby causing the boundary of the foreground, namely the object, to shrink temporarily.

On the other hand, the left edge of the non-flat portion is expanded from the left boundary of the object as indicated by the bold line in FIG. 8(A). As a result, the processing by the MIN filter 702 is not performed on the left side of the boundary of the object, thereby causing the position of the boundary to remain the same as indicated by the chain line in FIG. 8(B).

When the MAX filter 703 is applied directly to the parallax image output by the MIN filter 702, the parallax is expanded toward the background at both right and left edges of the boundary of the object as indicated by a dotted line in FIG. 8(C), thereby allowing the intended effect to be exerted. The number of taps of the MAX filter 703 and the number of taps of the MIN filter are assumed such that the number of taps of the MIN filter 702 equals no less than one time and no more than two times as many as the number of taps of the MAX filter 703. As a result, the right and left edges of the parallax of the object can be expanded by the MAX filter 703 as intended.

Moreover, as indicated by a bold line in the example illustrated in FIG. 9(A), the object is placed toward the background. In this case, the left edge of the non-flat portion is expanded outside (to the background side) from the left boundary of the object, so that the processing by the MIN filter 702 is not performed on the left edge of the boundary of the object. However, the MIN filter 702 is applied to a portion where the non-flat portion is switched to the flat portion so that the parallax of the background is copied to temporarily cause an unnecessary isolated point in the background separated from the object (background) on the left side of the boundary of the object as indicated by a chain line in FIG. 9(B).

On the other hand, the right edge of the non-flat portion is shrunk from the right boundary of the object as indicated by the bold line in FIG. 9(A). Accordingly, the processing by the MIN filter 702 is applied to the right side of the boundary of the object so that the boundary of the object (background) is expanded toward the foreground (or to the right in the figure) as indicated by a chain line in FIG. 9(B).

When the MAX filter 703 is directly applied to the parallax image output by the MIN filter 702, the boundary of the foreground is expanded toward the background. An unnecessary isolated point in the background as indicated by the chain line in FIG. 9(B) is temporarily generated on the left side of the left boundary of the object but, by further applying the MAX filter 703, the parallax in the foreground is expanded so that the isolated point is removed as indicated by a dotted line in FIG. 9(C). This is because the number of taps of the MAX filter 703 and the number of taps of the MIN filter are assumed such that the number of taps of the MIN filter 702 equals no less than one time and no more than two times as many as the number of taps of the MAX filter 703.

Moreover, the right side of the boundary of the object is expanded toward the foreground (or to the right in the figure) by applying the MIN filter 702 and recedes toward the background (or to the left in the figure) by further applying the MAX filter 703. As compared with the initial parallax image, the right edge of the boundary of the object can still be expanded toward the foreground that is toward the background as indicated by the dotted line in FIG. 9(C). This is because the number of taps of the MAX filter 703 and the number of taps of the MIN filter are assumed such that the number of taps of the MIN filter 702 equals no less than one time and no more than two times as many as the number of taps of the MAX filter 703.

Looking at the corrected result of the parallax image indicated by the dotted line in FIG. 9(C), as a whole, one can say that the intended effect can be exerted as the corrected result is expanded toward the background with respect to the initial parallax image.

According to the present embodiment, the stereoscopic effect in the naked eye three-dimensional image or the like can be stabilized efficiently by focusing on the characteristic that the stereoscopic effect is more unstable at the boundary between the object in the foreground and the flat background to use the information on the flat portion of the original image and perform the processing of expanding the boundary of the object toward the background with use of the MAX filter.

Moreover, according to the present embodiment, the stereoscopic effect can be stabilized efficiently while using the MIN filter and the MAX filter together to stably perform the processing of expanding the boundary of the object toward the background, without depending on the detected precision of the flat portion, by temporarily processing the parallax image with the MIN filter with use of the flat information of the image and then applying the MAX filter.

Note that the technology disclosed in the present description can adopt the following configuration as well.

(1) An image processing apparatus including: a flat portion detection unit which detects a flat portion of an original image; a MIN filter which inputs a parallax image of the original image and performs processing on the flat portion detected by the flat portion detection unit to expand a parallax in a background toward a direction of a foreground; and a MAX filter which inputs the parallax image processed by the MIN filter and performs processing of expanding a parallax in the foreground toward a direction of the background.

(2) The image processing apparatus according to (1), where the number of taps of the MIN filter equals no less than one time and no more than two times as many as the number of taps of the MAX filter.

(3) An image processing method including: a flat portion detection step of detecting a flat portion of an original image; a MIN filtering step of inputting a parallax image of the original image and performing processing on the flat portion detected in the flat portion detection step to expand a parallax in a background toward a direction of a foreground; and a MAX filtering step of inputting the parallax image processed in the MIN filtering step and performing processing of expanding a parallax in the foreground toward a direction of the background.

(4) An image processing apparatus including: a flat portion detection unit which detects a flat portion of an original image; and a MAX filter which inputs a parallax image of the original image and performs processing on the flat portion detected by the flat portion detection unit to expand a parallax in a foreground toward a direction of a background.

(5) An image display device including: an initial parallax generation unit which generates an initial parallax from an original image; a parallax correction unit which performs MIN filter processing on a flat portion of the original image to expand a parallax in a background toward a direction of a foreground and then performs MAX filter processing of expanding a parallax in the foreground toward a direction of the background; an interpolation image generation unit which generates an interpolation image interpolating the original image on the basis of the corrected parallax; an image integration unit which integrates the original image and the interpolation image; and a display unit which displays the original image or the image integrated by the image integration unit.

### INDUSTRIAL APPLICABILITY

The technology disclosed in the present description has been described in detail with reference to the specific embodiments. However, it is apparent that those skilled in the art can modify or substitute the embodiments without departing from the gist of the technology disclosed in the present description.

The technology disclosed in the present description can be used to provide the stable stereoscopic effect in displaying the naked eye three-dimensional image, for example, but can also be applied to a case where the three-dimensional image is displayed by another method.

Moreover, the image processing according to the embodiments described in the present description can be executed by either hardware or software. When the processing is to be implemented by the software, a computer program may be installed to a predetermined computer to be executed, the computer program describing a procedure performed in the software in a computer-readable format.

In short, the present technology has been disclosed by way of illustration, and the contents described in the present description are not to be interpreted in a limited manner. One should take claims into consideration in order to assess the gist of the present technology.

### REFERENCE SIGNS LIST

100 Display device
110 Video display unit
112 Liquid crystal panel
113 Gate driver
114 Data driver
115 Light source
120 Video signal processing unit
140 Timing control unit
201 Image input unit
202 Interpolation frame generation unit
203 Image integration unit
301 Left image frame memory
311 Right image frame memory
302 Initial parallax calculation unit (with reference to left image)
312 Initial parallax calculation unit (with reference to right image)
303 Parallax memory (with reference to left image)
313 Parallax memory (with reference to right image)
304 Parallax correction unit (with reference to left image)
314 Parallax correction unit (with reference to right image)
305 Frame generation unit (with reference to left image)
315 Frame generation unit (with reference to right image)
306 Image output unit
401 Flat portion detection unit
402 MAX filter
701 Flat portion detection unit
702 MIN filter
703 MAX filter

1. An image processing apparatus comprising:
a flat portion detection unit which detects a flat portion of an original image;
a MIN filter which inputs a parallax image of the original image and performs processing on the flat portion detected by the flat portion detection unit to expand a parallax in a background toward a direction of a foreground; and
a MAX filter which inputs the parallax image processed by the MIN filter and performs processing of expanding a parallax in the foreground toward a direction of the background.

2. The image processing apparatus according to claim 1, wherein the number of taps of the MIN filter equals no less than one time and no more than two times as many as the number of taps of the MAX filter.

3. An image processing method comprising:
a flat portion detection step of detecting a flat portion of an original image;
a MIN filtering step of inputting a parallax image of the original image and performing processing on the flat portion detected in the flat portion detection step to expand a parallax in a background toward a direction of a foreground; and
a MAX filtering step of inputting the parallax image processed in the MIN filtering step and performing processing of expanding a parallax in the foreground toward a direction of the background.

4. An image processing apparatus comprising:
a flat portion detection unit which detects a flat portion of an original image; and
a MAX filter which inputs a parallax image of the original image and performs processing on the flat portion detected by the flat portion detection unit to expand a parallax in a foreground toward a direction of a background.

5. An image display device comprising:
an initial parallax generation unit which generates an initial parallax from an original image;
a parallax correction unit which performs MIN filter processing on a flat portion of the original image to expand a parallax in a background toward a direction of a foreground and then performs MAX filter processing of expanding a parallax in the foreground toward a direction of the background;
an interpolation image generation unit which generates an interpolation image interpolating the original image on the basis of the corrected parallax;
an image integration unit which integrates the original image and the interpolation image; and
a display unit which displays the original image or the image integrated by the image integration unit.
